(19) United States
(12) Patent Application Publication
(10) Pub. No.: US 2013/0009965 A1
(43) Pub. Date: Jan. 10, 2013

(54) ANIMATION DISPLAY DEVICE

(75) Inventors: Yoshiyuki Kato, Tokyo (JP); Akira Torii, Tokyo (JP)

(73) Assignee: Mitsubishi Electric Corporation, Tokyo (JP)

(21) Appl. No.: 13/636,141

(22) PCT Filed: Mar. 30, 2010
(86) PCT No.: PCT/JP2010/002322

§ 371 Date: Sep. 20, 2012

(51) Int. Cl. G06T 13/00

(52) U.S. Cl. 345/474

(57) ABSTRACT

A converter 1 converts a plurality of animation data 101a, 102a, and 103a into a plurality of motion data 201, 202, and 203 which can be processed by an animation drawing engine 2, respectively. The converter also generates motion control information 204 for specifying the size, the position, and the number of display frames of each animation at a time of displaying the plurality of motion data 201, 202, and 203 on a screen as parts. An animation drawing engine 2 carries out animation drawing of the plurality of motion data using vector graphics in accordance with the motion control information 204.

### FIELD OF THE INVENTION

The present invention relates to an animation display device which is used as, for example, an information display device installed in a train, to display animation data.

### BACKGROUND OF THE INVENTION

Conventionally, in, for example, a railway car, a display device which displays information about the states of trains in operation is used. As such a display device, there is provided a display device which displays operation information about the states of trains in operation, such as information about delays on trains, in each car of a train, as described in, for example, patent reference 1. Further, there is provided a display device which generates an animation screen display of traffic information or vehicle information in a vehicle such as a car (for example, refer to patent reference 2 and patent reference 3).

### RELATED ART DOCUMENT

### Patent Reference

Patent reference 1: Japanese Unexamined Patent Application Publication No. 2009-67252

Patent reference 2: Japanese Unexamined Patent Application Publication No. 2005-49138

Patent reference 3: Japanese Unexamined Patent Application Publication No. 2005-119465

However, the conventional display devices as shown in above-mentioned patent references 1 to 3 do not have any explicitly written concrete structure for combining a plurality of animation screens freely on the same screen, and displaying them intelligibly. Further, Java (registered trademark) by Sun Microsystems, Inc., Flash Player (registered trademark, omitted hereafter) by Adobe Associates, Inc., Silverlight (registered trademark) by Microsoft Corp., etc. are used typically and widely for animation display which uses vector graphics (path rendering) in a personal computer and in built-in equipment. Each of these animations is used as a plug-in of a browser in many cases. In the case of a stand-alone computer, each animation is displayed as a single complete window screen display in most usage patterns. Therefore, it is difficult to display a plurality of animations simultaneously, and to establish synchronization between animations and perform control on a per-frame basis. As a result, it is difficult to start another animation display after the display of a certain animation is completed, and to end the display of two animations at completely the same time, for example.

The present invention is made to solve the above-mentioned problems, and it is therefore an object of the present invention to provide an animation display device which can combine a plurality of animation screens freely, and which can display the plurality of animation screens intelligibly.

### SUMMARY OF THE INVENTION

An animation display device in accordance with the present invention is constructed in such a way as to convert a plurality of animation data into a plurality of motion data which can be processed by a drawing device, respectively, generate motion control information for specifying the size, the position, and the number of display frames of each animation at a time of displaying these motion data on a screen as parts, and carry out animation drawing of the plurality of motion data using vector graphics in accordance with this motion control information. Therefore, the animation display device can combine a plurality of animation screens freely and display these animation screens intelligibly.

### BRIEF DESCRIPTION OF THE FIGURES

FIG. 1 is a block diagram showing an animation display device in accordance with Embodiment 1 of the present invention;

FIG. 2 is an explanatory drawing showing an example of the data format of motion control information in the animation display device in accordance with Embodiment 1 of the present invention;

FIG. 3 is an explanatory drawing showing a concrete example of a display list and a display operation of the animation display device in accordance with Embodiment 1 of the present invention;

FIG. 4 is a view showing the structure of motion data in the animation display device in accordance with Embodiment 1 of the present invention;

FIG. 5 is an explanatory drawing showing an example of the format of motion data in the animation display device in accordance with Embodiment 1 of the present invention;

FIG. 6 is an explanatory drawing showing a data position reference table and a data block in the animation display device in accordance with Embodiment 1 of the present invention;

FIG. 7 is an explanatory drawing showing a transition in an animation display with time in the animation display device in accordance with Embodiment 1 of the present invention;

FIG. 8 is an explanatory drawing showing a transition of an animation display with time in a case in which the contents of a register are rewritten in the animation display device in accordance with Embodiment 1 of the present invention;

FIG. 9 is a block diagram showing an animation display device in accordance with Embodiment 2 the present invention;

FIG. 10 is an explanatory drawing showing an example of the data format of a bitmap in the animation display device in accordance with Embodiment 2 of the present invention;

FIG. 11 is a block diagram showing an animation display device in accordance with Embodiment 3 of the present invention;

FIG. 12 is an explanatory drawing showing an antialiasing process performed by an animation drawing engine in an animation display device in accordance with Embodiment 4 of the present invention;

FIG. 13 is an explanatory drawing showing a state in which minute line segments are processed by using a combination of straight line cells and corner cells in the animation display device in accordance with Embodiment 4 of the present invention;

FIG. 14 is an explanatory drawing showing an example of an inside and outside determining process which is performed on minute line segments by the animation display device in accordance with Embodiment 4 of the present invention;

FIG. 15 is an explanatory drawing showing another example of the inside and outside determining process which is performed on minute line segments by the animation display device in accordance with Embodiment 4 of the present invention; and

FIG. 16 is an explanatory drawing showing another example of calculation of the intensity of antialiasing in the animation display device in accordance with Embodiment 4 of the present invention.

### EMBODIMENTS OF THE INVENTION

Hereafter, in order to explain this invention in greater detail, the preferred embodiments of the present invention will be described with reference to the accompanying drawings. Embodiment 1.

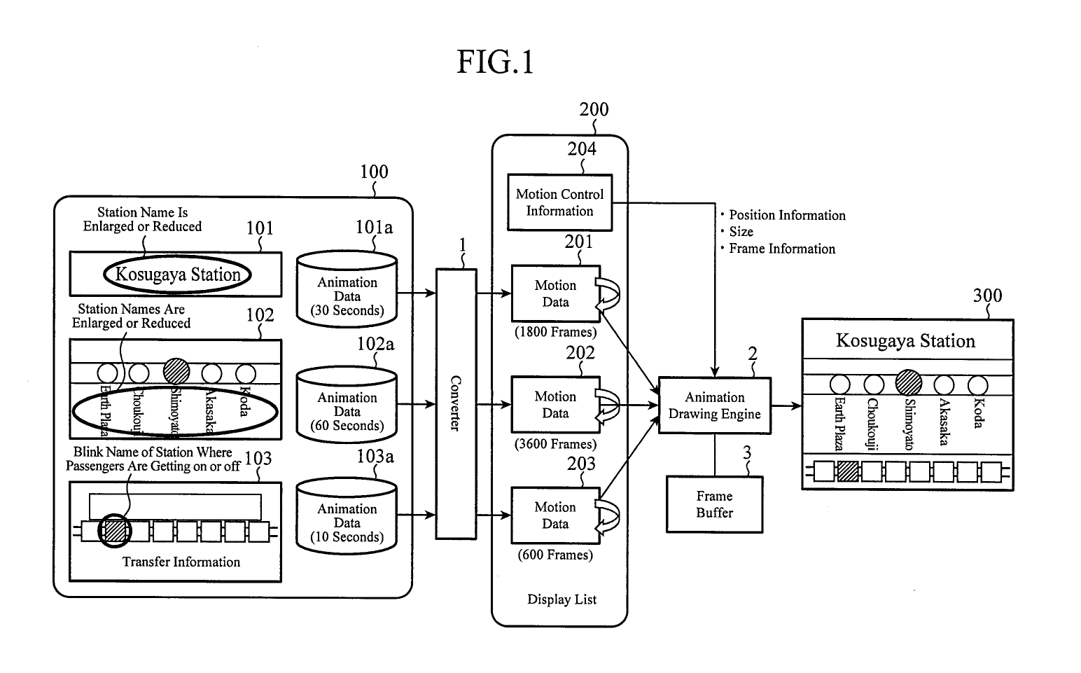

FIG. 1 is an explanatory drawing showing the structure of an animation display device in accordance with this Embodiment 1, and input and output images in the animation display device. The animation display device shown in FIG. 1 is the one which implements an animation screen display intended for display of information in a certain train. The animation display device shown is provided with a converter 1 for receiving animation part data 100 and for outputting a display list 200, an animation drawing engine (drawing device) 2 for generating a final image 300 on the basis of the display list 200, and a frame buffer 3. The animation display device is implemented using a computer, and the converter 1 and the animation drawing engine 2 can consist of either pieces of software associated with their respective functions and pieces of hardware including a CPU and a memory for executing the pieces of software, or pieces of hardware for exclusive use, respectively.

In this embodiment, it is assumed that a single screen consists of three animation parts 101,102, and 103. These animation parts 101,102, and 103 are designed by using a not-shown animation generating tool, and animation data 101a, 102a, and 103a are generated by using the generating tool. When Flash Player is used as an example of the animation generating tool, the animation data 101a, 102a, and 103a are SWF format files. The playback time durations of the animation data 101a, 102a, and 103a can differ from one another. In the case of FIG. 1, the animation part 101 has a playback time duration of 30 seconds, the animation data 102a has a playback time duration of 60 seconds, and the animation data 103a has a playback time duration of 10 seconds.

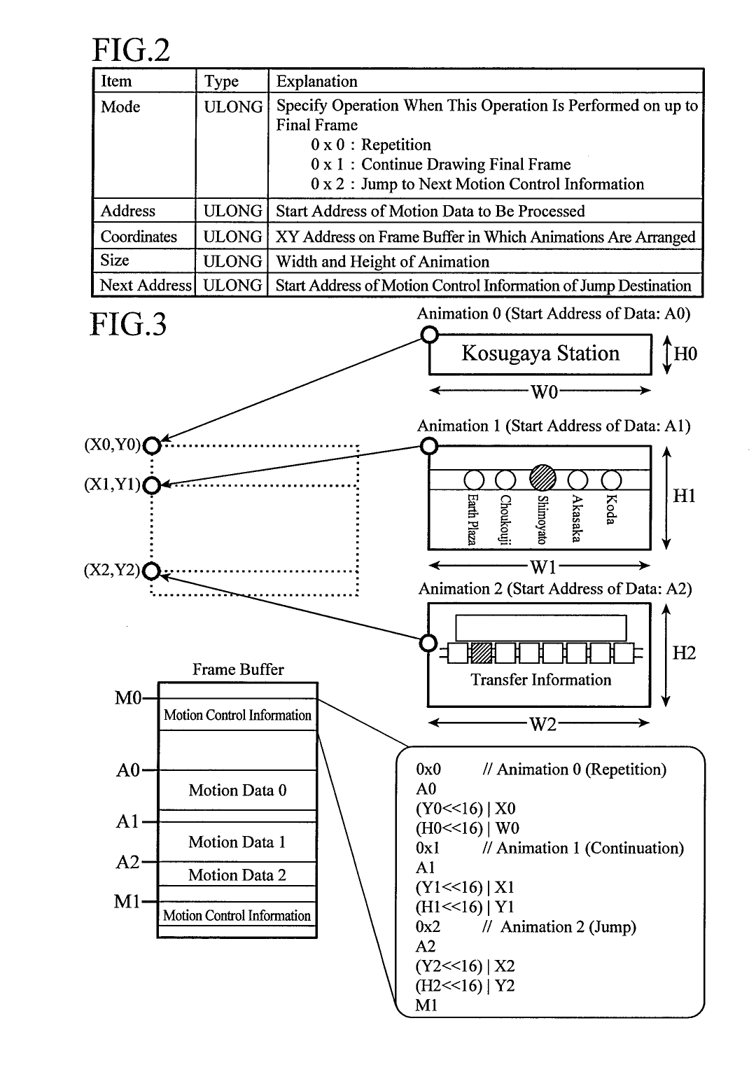

The converter 1 converts each of the animation data 101a, 102a, and 103a into a drawing command (referred to as motion data from here on) to be inputted to the animation drawing engine 2. Motion data 201, 202, and 203 in the display list 200 are data into which the animation data 101a, 102a, and 103a are converted by the converter 1, respectively. Motion control information 204 is needed in order to arrange the animation parts 101,102, and 103 on the screen (the motion control information includes the display positions and the sizes of the animation parts, and frame information). As the frame information, a stop of animation, a repetition, a jump (a transition to another animation), or the like can be specified for each animation part. The converting process is usually carried out off-line. An example of the detailed data format of the motion control information 204 is shown in FIG. 2.

The animation drawing engine 2 carries out a drawing process of drawing vector graphics, and carries out high-definition drawing at an arbitrary resolution by using path rendering. The animation drawing engine 2 reads the series of motion data 201, 202, and 203 in the display list form, and draws each of the animations with a specified size and at a specified position in accordance with the motion control information 204. The animation drawing engine performs the drawing on the frame buffer 3. When the frame buffer 3 and a main storage unit of the computer are shared, the animation drawing engine performs the drawing on the main storage unit. Because each animation is processed by using a vector graphics method, no degradation occurs in the image quality even if the animation is enlarged or reduced in size, unlike in the case of processing a bitmapped image, and an antialiasing process is also performed on each of the animations. Finally, an image drawn in the frame buffer 3 is transferred to a display (not shown), such as an LCD, and a final image 300 is displayed on the display.

FIG. 3 shows a concrete example of the motion control information 204 and the display list 200 which constructs the motion data 201, 202, and 203, and the operation of the animation display device. The display list 200 is stored in the frame buffer or the main storage unit of the computer, and is accessed by the animation drawing engine 2 as a master. In the example shown in FIG. 3, a single screen consists of an animation 0, an animation 1, and an animation 2, and the numbers of frames of the animations 0, 1, and 2 are 1800, 3600, and 600, respectively. It is assumed that the motion data are stored at addresses A0, A1 and A2 on the frame buffer, respectively. Mode information which is motion control information specifies an operation which is performed on up to the final frame, as shown also in FIG. 2.

In the example shown in FIG. 3, a repetition display starting from the frame of No. 0 after the 1800 frames have been displayed is specified for the animation 0, a continuous display of the final frame after the 3600 frames have been displayed is specified for the animation 1, and a transition to another animation after the 600 frames have been displayed is specified for the animation 2. The animation information about the transition destination is specified by other motion control information. By thus preparing two or more pieces of motion control information, the animation display device can carry out a jump process of making transition from an animation to another animation, and, after drawing the final frame of the animation, can start the other animation to change the scene.

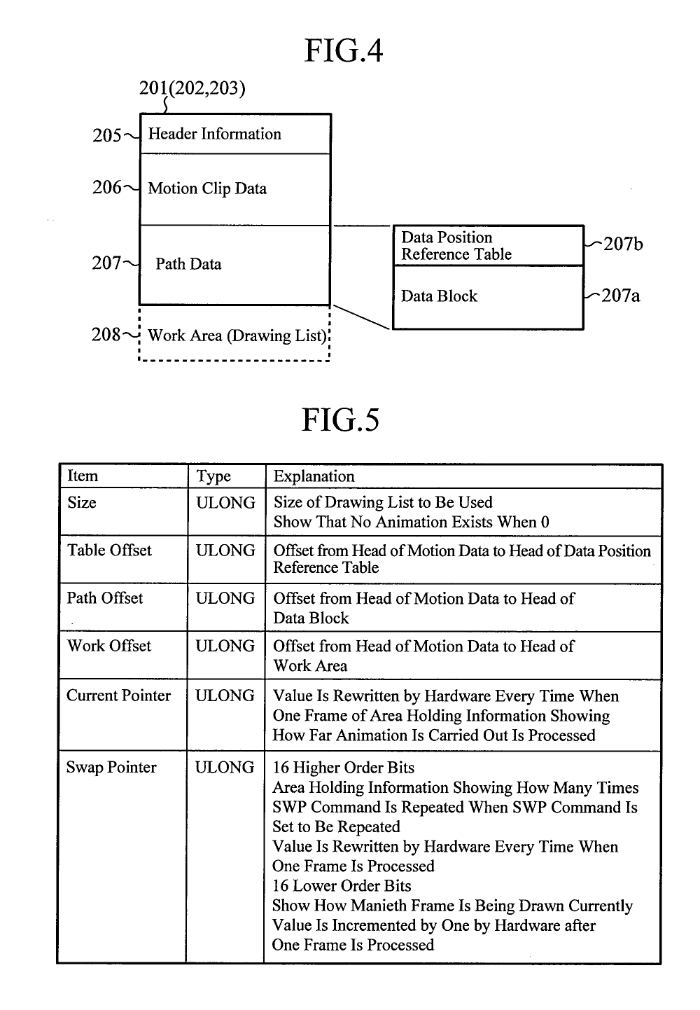

FIG. 4 is a view of the detailed structure of the motion data 201, 202, and 203. Each of the motion data 201, 202, and 203 is comprised of blocks which are header information 205, motion clip data 206, path data 207, and a work area 208. The header information 205 is the block including basic information about the corresponding one of the motion data 201, 202, and 203, and the detailed format of the header information is as shown in FIG. 5. The motion clip data 206 is used for carrying out an animation display, and defines which graphic is to be drawn at which position for each frame. Which graphic is to be drawn is specified by an index value of the path data 207. At which position each graphic is to be drawn is specified by a transformation matrix. Because the transformation matrix has three rows and two columns, enlargement, reduction, rotation, parallel translation, or the like can be carried out on each graphic. By further specifying color conversion, each graphic can be drawn into a converted color and a converted degree of opacity which are respectively different from a drawing color and a degree of opacity which are defined in the path data 207. The motion clip data 206 can consist of only difference information about a difference between the current frame and the preceding frame for reduction in the data volume.

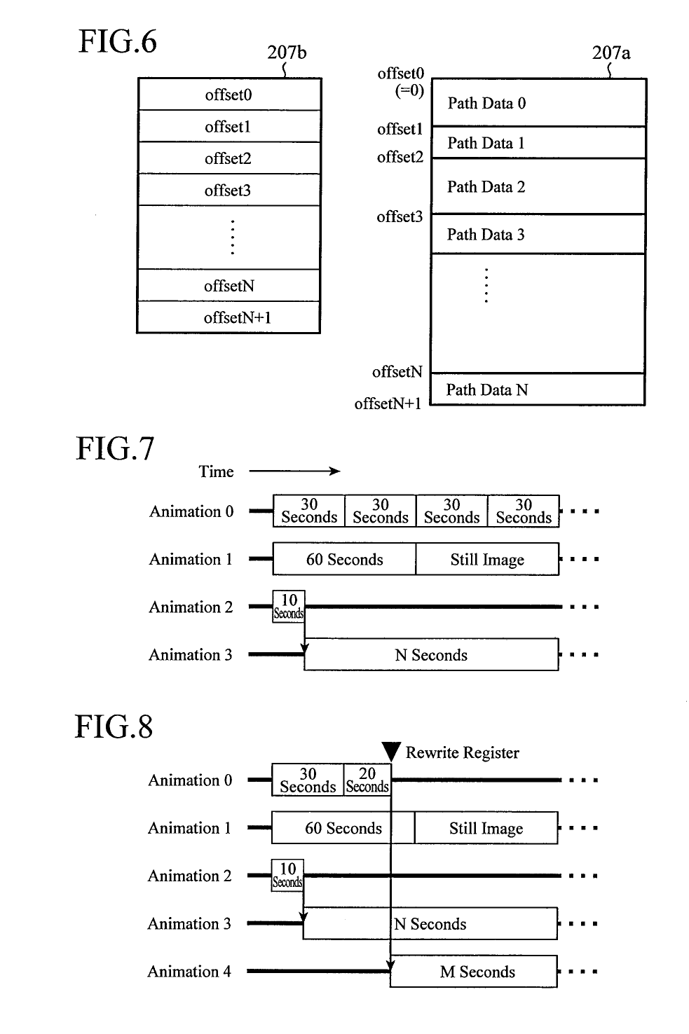

The path data 207 are vector data for defining each graphic which is to be drawn using vector graphics. Information about the definition of the shape (edge) of each graphic and information about attributes (a drawing color etc.) of each graphic are included in the path data 207. As shown in FIGS. 4 and 6, the path data 207 consist of a data block 207a in which a plurality of path data 207 are put together, and a data position reference table 207b showing at which position in the data block 207a each of the path data 0, 1, 2, . . . , and N is located. The data block 207a is comprised of the plurality of path data 0, 1, 2, and N, and each of the path data 0, 1, 2, and N stores a path which defines the edge of a corresponding graphic, and an attribute value. The path stored in each of the path data 0, 1, 2, and N can be either a simple path which directly defines the coordinates of the edge, the drawing color, etc. (which corresponds to a simple glyph in font), or a composite path which defines the coordinates of the edge, the drawing color, etc. by using a combination of a plurality of simple paths (which corresponds to a composite glyph in font). The grouping of graphics can be done when a composite path is used as the path stored in each of the path data. The work area 208 is used for storing a drawing list at the time of processing the motion data 201, 202, and 203 by using hardware. When processing the drawing of the series of motion data 201, 202, and 203, the work area is used in order to restore the next frame to the state shown by the motion data.

FIG. 7 shows a change in the display of each animation with time. In the case of the animation 0, the same animation display is repeated every 30 seconds. In the case of the animation 1, a still image of the final frame continues being displayed after the animation 1 has been displayed for 60 seconds. In the case of the animation 2, a transition to another animation 3 is made after the animation 2 has been displayed for 10 seconds.

On the other hand, the animation display device can also change the action of each animation dynamically by causing the CPU to rewrite the contents of a register of the animation drawing engine 2. The register is the one in which read motion control information 204 is written. For example, as shown in FIG. 8, when the CPU rewrites the mode information which is motion control information 204 of the animation 0 with a jump mode after the animation 0 has been displayed for 50 seconds, a transition from the animation 0 to an animation 4 at the time of the next frame. As a result, the CPU can control a transition from an animation to another animation freely by using information inputted thereto from outside the animation display device. For example, the animation display device can provide an animation display of operation information about delays on trains in operation or the like on a display in each car of a train, as an emergency message, for passengers on the basis of information distributed thereto from an operation information center of a railroad, or the like.

By thus setting up motion data 201, 202, and 203 into which animation data 101a, 102a, and 103a are converted in advance, and motion control information 204 including a layout of each animation and a transition of the state of each animation, a display of an operation screen including automatic animations can be implemented without imposing any load on the CPU. Conventionally, a text screen display is generated mainly, and complete switching between bitmap picture-story boards is carried out typically. In contrast, the animation display device in accordance with the present embodiment can generate an intuitive and intelligible screen display which enables passengers to grasp the whole of a railroad map by providing an animation display, such as a smooth enlargement, a smooth reduction, a scroll, or a blink. Because the animation display device can further generate a high-quality and smooth animation screen display including characters, the visibility of a telop or the like can also be improved.

Further, when dynamic animation control is needed, the animation display device can control the transition of the state of each animation by causing the CPU to rewrite the contents of the register. Further, because the animation display device uses the results of conversion of animation data generated by a generating tool used typically and widely as an animation content, the animation display device can improve the efficiency of the development of contents. By modifying and changing the format of the input to the converter 1, the animation display device can support various animation generating tools.

As previously explained, the animation display device in accordance with Embodiment 1 includes the converter for converting a plurality of animation data which are created by an animation generating tool into a plurality of motion data which can be processed by the drawing device, respectively, and for creating motion control information for specifying the size, the position, and the number of display frames of each animation at the time of displaying the plurality of motion data on the screen as parts, and the drawing device receives the plurality of motion data and the motion control information as its inputs and carries out animation drawing using vector graphics. Therefore, the animation display device in accordance with Embodiment 1 can combine a plurality of animation screens freely and display these animation screens intelligibly.

### Embodiment 2

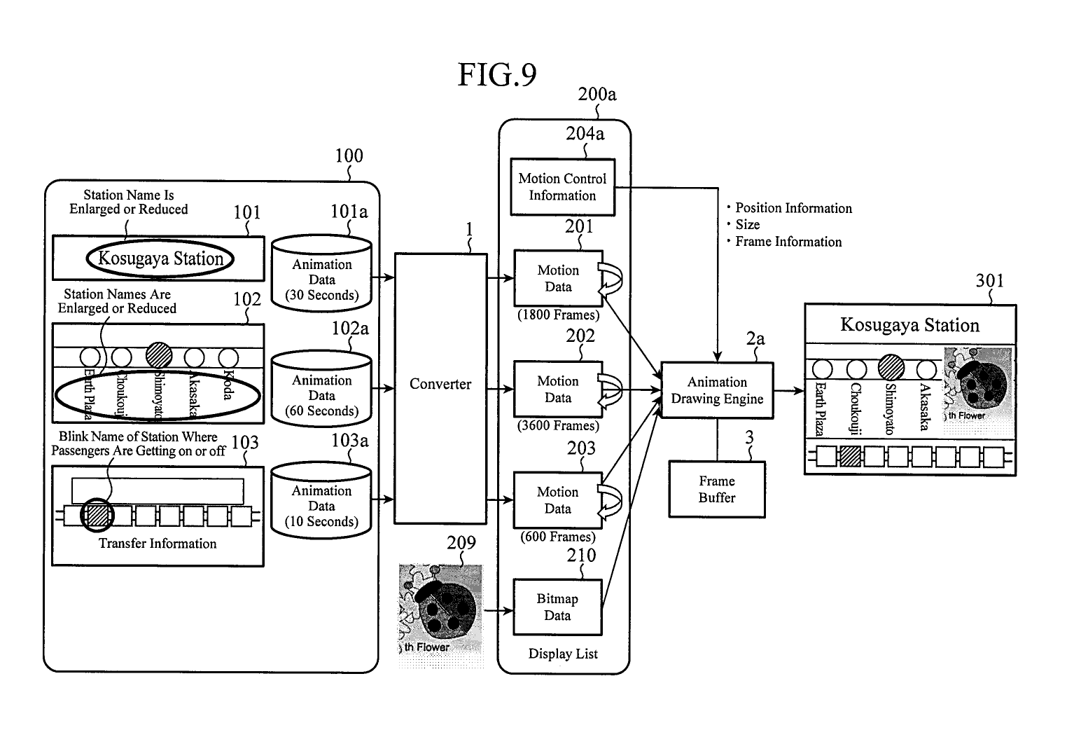

An animation display device in accordance with Embodiment 2 is constructed in such a way as to also support a bitmapped image as an animation part. FIG. 9 is a block diagram showing the animation display device in accordance with Embodiment 2. Referring to FIG. 9, a bitmapped image 209 is displayed on the screen, like animation part data 100, and bitmap data 210 are data about the bitmapped image 209 which an animation drawing engine 2a can draw. The animation drawing engine 2a has the same functions as that in accordance with Embodiment 1 while reading a display list 200a, and, when mode information which is motion control information 204a shows a bitmap mode, copying the bitmap data 210 from a specified address to a frame buffer 3 by using BitBlt (Bit Block Transfer). When an enlargement or reduction of the bitmap image is needed, the animation drawing engine carries out a mapping process of mapping the bitmapped image by using a texture mapping function for vector graphics instead of using BitBlt. Because processes performed by the animation display device other than the bit mapping process are the same as those performed by the animation display device in accordance with Embodiment 1, the explanation of the processes will be omitted hereafter. The bitmap mode shown by the motion control information 204a is the one in which a bitmap identifier (0x3) is added to the mode information shown in FIG. 2, and the address is a start address showing a location where the bitmapped data are stored.

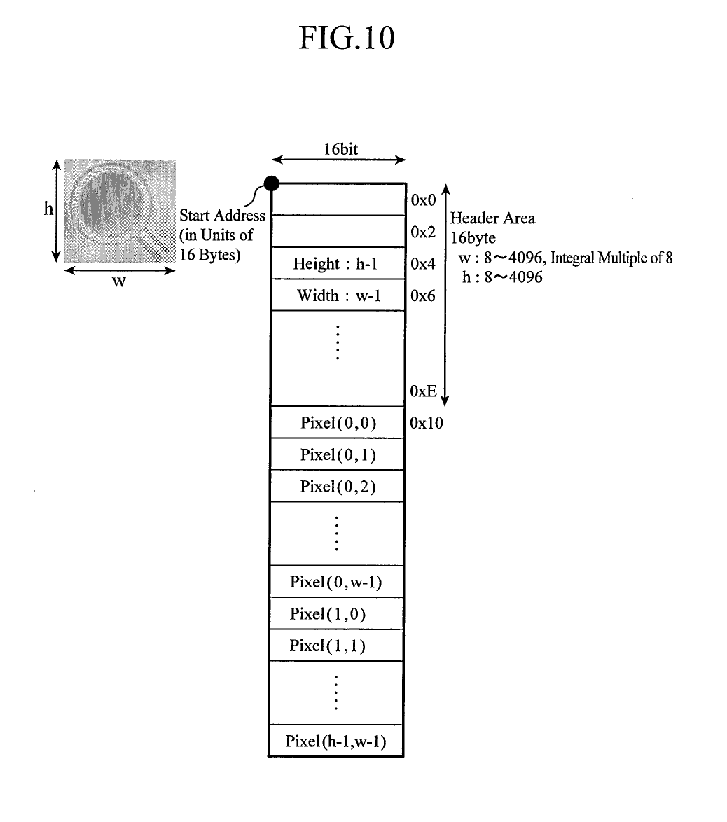

An example of the data format of the bitmapped data having a 16-bit pixel format is shown in FIG. 10. The higher order 16 bytes of the bitmapped data are a header area, and the width, the height, and so on of the bitmapped image are specified in this header area. The animation drawing engine 2a generates a final image 301 to be displayed in an area specified by motion control information 204a in accordance with this data format.

As mentioned above, in the animation display device in accordance with Embodiment 2, a drawing device accepts bitmapped image data inputted thereto, and, when a display of the bitmapped image data is specified by motion control information, draws the bitmapped image data in accordance with the motion control information. Therefore, the animation display device can generate an animation screen display and a bit screen map display in such a way that they coexist, and can generate a display of a content, such as a photograph, which cannot be expressed by using vector graphics.

### Embodiment 3

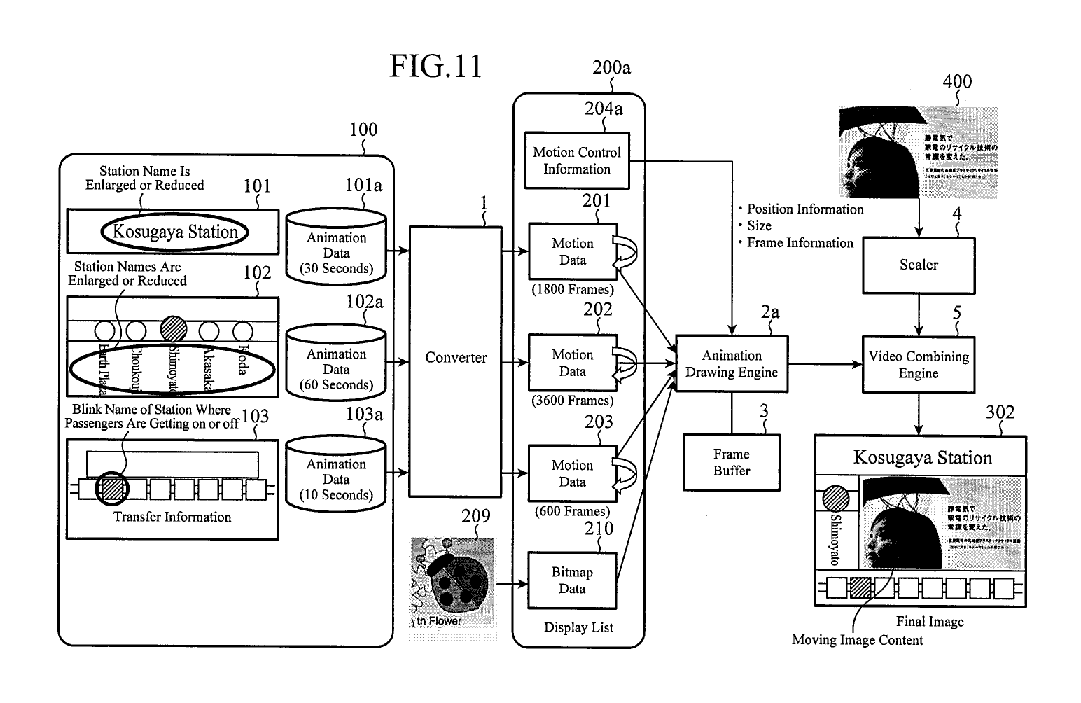

An animation display device in accordance with Embodiment 3 is constructed in such a way as to generate a composite screen display of a moving image content. FIG. 11 is a block diagram showing the animation display device in accordance with Embodiment 3. The device shown in the figure is constructed in such a way as to implement a composite screen display of a moving image content (moving video image), in addition to an animation screen display in accordance with Embodiment 2. A scaler 4 carries out resolution conversion on an inputted digital video image 400, and outputs the digital video image to a video combining engine 5. For example, the scaler receives RGB data about a full-HD digital image of 1920×1080 as the inputted image 400, and carries out scale conversion, such as enlargement or reduction, on the RGB data about the full-HD digital image. The video combining engine 5 is a display combining unit for combining the image from the scaler 4 and an image from an animation drawing engine 2a into a composite image, and outputs this composite image as a final image 302. The video combining engine can carry out the combining process by using alpha blend, and can generate a composite image by using either fixed alpha values or alpha values outputted from the animation drawing engine 2a which differ in accordance with pixels. Because the animation display device can generate a composite of an animation screen display and a screen display of a moving video image, the animation display device can display the composite image on a single screen while changing the size of an operation information screen display and the size of an advertising moving image. The animation display device controls the enlargement/reduction ratio of the scaler 4 by causing a CPU to change the size of the moving video image. As a result, the animation display device can generate a screen display including an operation information screen and an advertisement screen in accordance with the states of trains in operation. For example, the animation display device usually displays an advertising moving image in full screen, and displays the operation information screen in a larger size at a time when the train equipped with the animation display device is approaching a station or in an emergency while displaying the advertisement moving image in a smaller size, thereby being able to exactly notify passengers about information which they most want to know.

Although the animation display device in accordance with above-mentioned Embodiment 3 is constructed in such a way as to have a structural component for combining a moving image content with an animation, in addition to the structural components in accordance with Embodiment 2, the animation display device can be alternatively constructed in such a way as to have the structural component for combining a moving image content with an animation, in addition to the structural components in accordance with Embodiment 1.

As mentioned above, because the animation display device in accordance with Embodiment 3 includes the display combining unit for receiving a moving image content inputted thereto, and for superimposing the moving image content onto screen data drawn by a drawing device, the animation display device can make an animation screen display and the moving image content coexist on the screen thereof.

### Embodiment 4

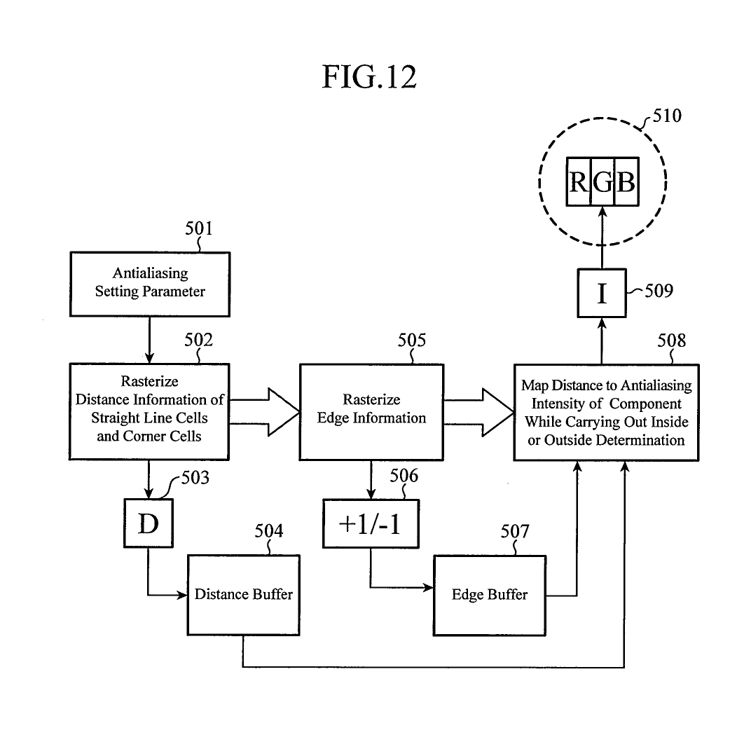

In Embodiment 4, the details of the antialiasing process carried out by each of the animation drawing engines 2 and 2a will be shown. FIG. 12 is an explanatory drawing showing the details of the antialiasing process carried out by each of the animation drawing engines 2 and 2a. An antialiasing setting parameter 501 is set to specify the intensity of antialiasing which is performed on path data, and is shown by an external cutoff and an internal cutoff. The amount of blurring of an edge portion of an object can be increased with increase in a cutoff value whereas the amount of blurring of the edge portion can be increased with decrease in the cutoff value. By decreasing the cutoff value to 0, the edge portion can be changed to an edge with jaggies which is equivalent to an edge on which no antialiasing is performed. Further, an effect of fattening the entire object is produced by setting the external cutoff value to be larger than the internal cutoff value while an effect of thinning the entire object is produced by setting the external cutoff value to be smaller than the internal cutoff value.

Next, the animation drawing engine carries out a rasterizing process on minute line segments, which are generated by dividing the edge portion, by using a combination of straight line cells and corner cells in accordance with the antialiasing setting parameter 5 (the rasterizing process is designated by 502 in FIG. 12) to calculate a distance value 503 corresponding to each pixel of a display, and write this distance value in a distance buffer 504. The distance value 503 of each pixel ranges from −1 to 1, and is expressed by 0 when the pixel is on the edge line. When the distance value is negative, the distance value shows that the pixel is located outside the object.

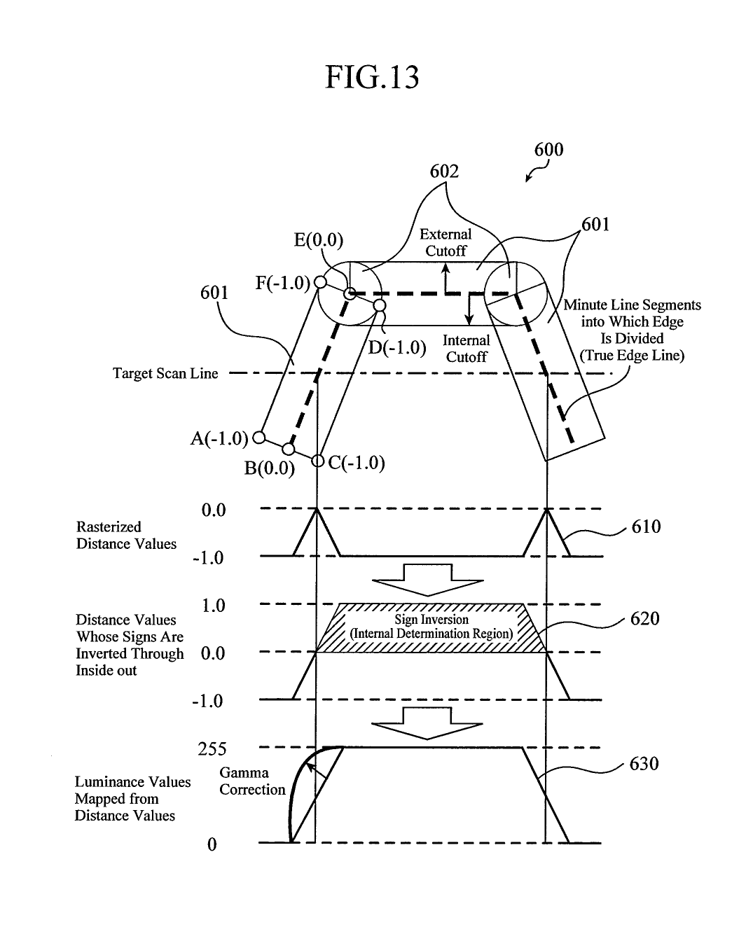

FIG. 13 shows a state in which that the minute line segments 600 are processed by using a combination of straight line cells 601 and corner cells 602. Each straight line cell 601 consists of a rectangle ABEF on a side of the external cutoff, and a rectangle BCDE on a side of the internal cutoff. A larger one of the widths of both the rectangles is selected from a comparison between the external cutoff value and the internal cutoff value. Because each minute line segment is also a part of the true edge line, the distance value of any point on each minute line segment is expressed as 0. Because whether each pixel is located inside and outside the object is yet to be solved at this stage, the distance value of each vertex on each cutoff side is uniformly set to −1. Therefore, the distance values of the vertices of the rectangle ABEF are defined as −1, 0, 0, and −1, and the distance values of the vertices of the rectangle BCDE are defined as 0, −1, −1, and 0. After the rectangles ABDE and BCDE are determined, the distance value is generated for each pixel through the rasterizing process. In the rasterizing process, the animation drawing engine can calculate an increment of the distance value in an X direction and an increment of the distance value in a Y direction in advance, and can calculate the distance value at a high speed by carrying out a linear interpolation process in a direction of scan lines.

On the other hand, each corner cell 602 consists of a perfect circle having a radius of either the external cutoff value or the internal cutoff value. The distance value at the central point of the circle can be expressed as 0, and the distance value on the circumference of the circle can be expressed as −1. Although the distance from each pixel to the central point can be calculated by using the following equation (1),

\sqrt{x²+y²} (1)

the distance can be alternatively calculated at a high speed through a rough calculation using a look-up table.

Each straight line cell 601 and corner cells 602 are rasterized into the distance buffer 504 for each pixel with them being overlapped partially. Therefore, in order to store the largest distance value, the animation drawing engine makes a comparison between the distance value at the source and the distance value at the destination when writing the largest distance value in the distance buffer, and then writes the larger one of the distance values (a value closer to 0) in the distance buffer. By thus rasterizing the minute line segments by using a combination of straight line cells 601 and corner cells 602, the animation drawing engine can generate exact distance information needed for the antialiasing process even for the connecting portion between any two minute line segments at a high speed without leaving any space where no distance information is generated.

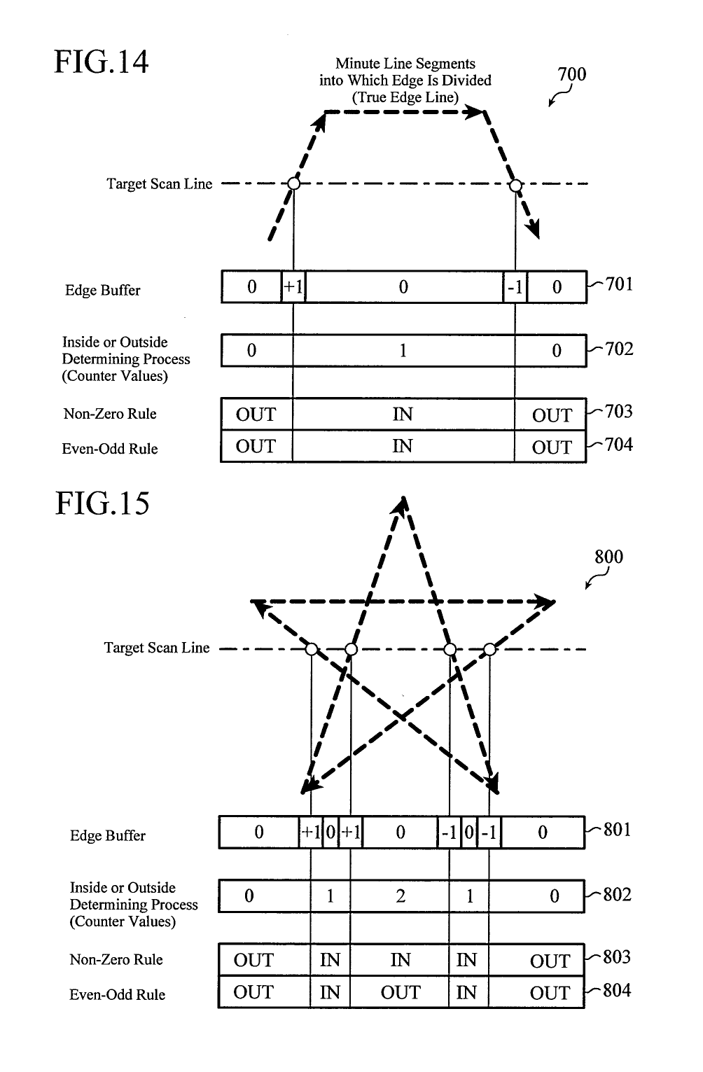

On the other hand, the animation drawing engine performs a rasterizing process on the edge information of each of the minute line segments which are generated by dividing the edge portion (the rasterizing process is designated by 505 in FIG. 12) to write the information 506 in an edge buffer 507. When performing the rasterizing process on the edge portion, the animation drawing engine calculates coordinates to be drawn from the start point coordinates and end point coordinates of each minute line segment by using a DDA (Digital Differential Analyzer), and performs a process of adding +1 to the edge data stored in the edge buffer 507 when the edge is directed upwardly, as shown in FIGS. 14 and 15, or adding −1 to the edge data stored in the edge buffer 507 when the edge is directed downwardly. For example, when it is defined that edges are allowed to overlap at the same coordinates up to 128 times, 8 bits (2⁷=128+sign bit) are needed as the bit width in the depth direction of the edge buffer 507. Further, in these FIGS. 14 and 15, reference numerals 700 and 800 denote minute line segments, reference numerals 701 and 801 denote the values in the edge buffer 507, reference numerals 702 and 802 denote values (counter values) each acquired through a determining process of determining whether each pixel is located inside or outside the object, reference numerals 703 and 803 denote values based on a Non-Zero rule, and reference numerals 704 and 804 denote values based on an Even-Odd rule.

After completing the rasterizing process on one piece of path data in the above-mentioned way, the animation drawing engine carries out the determining process of determining whether each pixel is located inside or outside the object to map the pixel onto the intensity 509 of antialiasing (the mapping is designated by 508 shown in FIG. 12) while reading the distance information about each pixel from the distance buffer 504, and also reading the edge information about each pixel from the edge buffer 507. Reference numeral 510 denotes one pixel of RGB on which the antialiasing process is to be carried out. Further, in FIG. 13, reference numeral 610 denotes distance values which are rasterized, reference numeral 620 denotes distance values whose signs are inverted through the inside or outside determining process, and reference numeral 630 denotes luminance values mapped from the distance values.

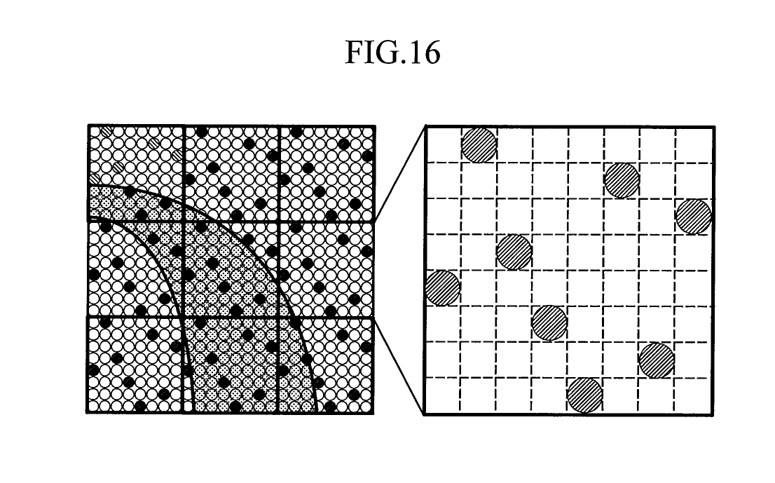

Further, as shown in FIG. 16, the animation drawing engine can calculate a coverage from discrete sampling points (eight points) using one pixel in an arrangement of 8 queens, instead of using the distance buffer 504. Although the animation drawing engine does not have to divide minute line segments into straight line cells and corner cells to draw distance values when using this method, the animation drawing engine needs to hold eight samples of edge buffer 507. As a result, each of the animation drawing engines 2 and 2a can process the enlarging or reducing drawing of motion data at a full rate (60 fps) while maintaining the image quality.

### INDUSTRIAL APPLICABILITY

As mentioned above, because the animation display device in accordance with the present invention combines several different animation parts and carries out a layout of the animation parts and frame synchronization between the animation parts freely on a single screen, thereby implementing an intelligible GUI screen and a display of a guidance screen, the animation display device in accordance with the present invention is suitable for a display intended for built-in equipment, such as a display for railroad cars, an in-vehicle display, a display for industrial use, an AV display, or a control panel in a household appliance or a portable terminal.

1. An animation display device comprising
a converter for converting a plurality of animation data which are created by an animation generating tool into a plurality of motion data which can be processed by a drawing device, respectively, and for generating motion control information for specifying a size, a position, and a number of display frames of each animation at a time of displaying said plurality of motion data on a screen as parts, wherein
said drawing device receives said plurality of motion data and said motion control information as its inputs and carries out animation drawing using vector graphics.

2. The animation display device according to claim 1, wherein when bitmapped image data is inputted thereto and the motion control information indicates a display of this bitmapped image data, the drawing device draws said bitmapped image data in accordance with said motion control information.

3. The animation display device according to claim 1, wherein said animation display device includes a display combining unit for receiving a moving image content to superimpose said moving image content on screen data drawn by the drawing device.
